(19) United States
(12) Patent Application Publication
(10) Pub. No.: US 2019/0275547 A1
(43) Pub. Date: Sep. 12, 2019

(54) PROCESS AND APPARATUS FOR APPLYING MASSES ONTO FOODS

(71) Applicant: DEUTSCHES INSTITUT FÜR LEBENSMITTELTECHNIK E.V, Quakenbrueck (DE)

(72) Inventor: Bernhard Hukelmann, Quakenbrueck (DE)

(21) Appl. No.: 16/294,580

(22) Filed: Mar. 6, 2019

(30) Foreign Application Priority Data
Mar. 6, 2018 (DE) 102018203339.0

(51) Int. Cl. B05B 13/02; B05B 12/00; B05B 7/24; A23P 20/18

(52) U.S. Cl. CPC B05B 13/0278; B05B 13/0221; A23P 20/18; B05B 7/2483; B05B 12/004

(57) ABSTRACT

Apparatus for applying masses onto foods and a process for producing coated foods that can be carried out thereby. A mass is applied onto foods using a flow channel at the inlet end of which a supply conduit for the mass is arranged, the mouth of which is fixed in a region which extends from a distance in front of the inlet end up to within the flow channel.

### PRIORITY CLAIM AND REFERENCE TO RELATED APPLICATION

The application claims priority under 35 U.S.C. § 119 and all applicable statutes and treaties from prior German Application DE 10 2018 203 339.0, which was filed Mar. 6, 2018.

### FIELD

The present invention relates to an apparatus and to a process for the application of masses, which are pulverized, preferably are liquid with pieces distributed therein, onto foods.

### BACKGROUND

WO 00/32051 describes the spraying of poultry pieces with liquid or pulverized additives by means of a gas jet by nozzles, which are not described further, also with electrostatic charging of 10-40 kV.

U.S. Pat. No. 3,436,230 describes nozzles by which without insertion liquid can be injected with so high a pressure into meat that its surface should not be damaged, e.g. with speeds of approximately 180 m/s.

### SUMMARY OF THE INVENTION

Embodiments of the invention provide an apparatus and a process that can be performed with it for application of masses onto foods, which are especially suitable to apply liquid masses that contain pieces in a contactless manner, especially by means of a gas stream.

### BRIEF DESCRIPTION OF THE DRAWINGS

The invention is now described in greater detail with reference to the Figures, which is schematically show in

FIG. 1 an embodiment of the apparatus according to the invention,

FIG. 2 a further embodiment of the apparatus according to the invention and,

FIG. 3 a further embodiment of the apparatus according to the invention,

FIG. 4 a further embodiment of the apparatus according to the invention,

FIG. 5 possible embodiments of the supply conduit, and in

FIG. 6 an embodiment of the apparatus according to the invention.

In the figures, embodiments are depicted in which the supply conduit is slidable, respectively slewable and can be fixed in a position. Therein, the positions in which the supply conduit is slidable, respectively slewable, indicate the positions in which the mouth of the supply conduit can be arranged in embodiments in which the supply conduit is fixed, respectively is not slidable and is not slewable.

### DETAILED DESCRIPTION OF THE PREFERRED EMBODIMENTS

A preferred apparatus for application of masses onto foods and a process for producing coated foods that can be performed with it, by applying a mass onto food, includes a flow channel, at the inlet end of which a supply conduit for the mass is arranged, the mouth of which is fixed in a region which extends from a distance in front of the inlet end up to inside the flow channel.

The liquid masses can be aqueous or oily or an emulsion. The liquid masses can have a consistency which at the temperature at which the process is performed, can be runny like water up to paste-like. The masses preferably contain pieces contained therein, e.g. up to a size of 0.5 mm or of 2 mm up to 10 mm, more preferred up to 5 or up to 3 mm in their largest extension. For application onto food the pieces can e.g. be spices, e.g. herbs, entire peppercorns, coarsely ground pepper, vegetable pieces, meat pieces or fat solid at 5 to 30° C., vegetable or animal fat. Optionally, the apparatus and the device can be set up to subsequently or concurrently apply at least two different masses separately, each onto the same or onto opposed sides of the food, in order to produce a food coated with the mass.

In an embodiment which advantageously can be produced in a simple manner and can be operated simply in the process, the apparatus has a flow channel which is provided with at least one pressurized gas supply, and a supply conduit which, preferably coaxially to the flow channel, discharges into a region within which the flow channel generates vacuum, wherein this region extends from a spacing in front of the inlet opening to inside the flow channel, or consists thereof. Therein, the supply conduit with its opposite open end can project into a container for the mass and preferably have no conveying device. Therein, the apparatus can be arranged below a transport device, e.g. with the longitudinal axis of the flow channel being vertical and its outlet opening on top. In this embodiment, the supply conduit is fixed and the arrangement of its mouth in a region in which the flow channel generates vacuum allows the self-acting suction of the mass. The supply conduit can be arranged with a spacing to the longitudinal central axis of the flow channel, or coaxially to the flow channel. Therein, the supply conduit can be arranged in an angle or in parallel to the longitudinal central axis of the flow channel. Preferably, the mouth of the supply conduit is arranged coaxially to the flow channel. Therein, the container for the mass can be a container having an open top, which is arranged below the transport device, optionally such that mass falling downwards from the direction of the transport device falls into the container.

Optionally, the supply conduit is guided slidably and/or slewably and can be fixed in a position such that its mouth can be arranged in a region which extends from a distance in front of the inlet end up to inside the flow channel. Further optionally, the mouth of the supply conduit is arranged coaxially to the longitudinal central axis of the flow channel.

The supply conduit is optionally connected to a supply container for a mass, optionally with at least two supply containers, each having a feed pipe and a valve, which can switch between the supply containers and can connect a supply container with the supply conduit. Each supply container by means of a pipe can be connected with the supply conduit which discharges in a region which extends from a distance in front of the flow channel to inside the flow channel.

Preferably a controlled conveyor device for conveying the mass to the mouth of the supply conduit is arranged in each pipe and/or in the supply conduit. For liquid masses the conveyor device is e.g. a pump or a positive-displacement pump, preferably a reciprocating pump, an eccentric screw pump, hose pump or centrifugal pump, spiral pump, membrane pump, impeller pump, rotary pump, vane-type rotary pump, rotary piston pump or gear pump. As an alternative conveyor device, a supply container can be put under pressure, e.g. by applying pressurized gas to the supply container, e.g. pressurized air by means of a pressurized air connection, preferably of constant pressure, or by forming a wall of the container, e.g. the lid, as a piston that is loaded against the inner volume of the supply container. Especially in embodiments in which the conveyor device is formed by applying pressure to the supply container, preferably a controlled valve is arranged in the supply conduit. Such a valve in the supply conduit can e.g. be controlled in dependence on the position of a transport device on which food is transported with a spacing past the outlet opening of the flow channel, or in dependence on a signal of a detector for the presence of a food arranged on the transport device in front of the outlet opening of the flow channel. Such a detector can be a photoelectric cell, preferably a camera.

For pulverized masses the conveyor device is e.g. a screw conveyor, a chute or a blower.

Optionally, in the supply conduit for the mass, no conveyor device is arranged, and optionally only the flow channel effects or supports the conveyance of the mass to the mouth of the supply conduit, especially by the vacuum generated by the flow channel, which vacuum acts onto the mouth of the supply conduit. With or without a conveying device within the supply conduit the vacuum generated by the flow channel which acts onto the mouth of the supply conduit can effect or support the conveyance of the mass through the supply conduit. Further optionally, a supply container, preferably all supply containers, for the mass are arranged above the mouth of the supply conduit, so that the mass is conveyed to the mouth by gravity. Therein, preferably a controlled valve is arranged in the supply conduit. Alternatively, the supply conduit has no valve.

Optionally, the conveyor device or the supply conduit is provided with a flowmeter.

The supply conduit optionally is guided slidably in relation to the flow channel and can be fixed in a position, preferably arranged coaxially to the longitudinal central axis of the flow channel, and guided slidably along this longitudinal central axis, especially in relation to the inlet end of the flow channel.

Optionally, the supply conduit is arranged in an angle to the longitudinal central axis of the flow channel and is fixed, or is slewable in an angle to the longitudinal central axis of the flow channel and can be fixed in a position. Optionally, the supply conduit is arranged and fixed in parallel or in an angle to the longitudinal central axis of the flow channel and/or the supply conduit is guided slewably in an angle to the longitudinal central axis of the flow channel, in one or in two dimensions which are perpendicular to the longitudinal central axis, slidably and/or slewably, and preferably can be fixed in a position.

A supply conduit that is slidable to the longitudinal central axis, e.g. by means of one or two linear guides, which form a guide for the supply conduit along one or respectively two axes in perpendicular to the longitudinal central axis of the flow channel, by means of which the supply conduit is slidably guided, allows for the eccentric supply, controlled into different positions, of the mass into the flow channel. In this manner, the apparatus is set up to vary the distribution of the mass in a controlled way, e.g. to influence the distribution of the particulate components in a controlled manner. The supply conduit can e.g. be guided slidably by means of at least one adjusting screw or at least one linear drive slidably in relation to the flow channel.

Generally, in embodiments in which the supply conduit is fixed, respectively is not slidable and/or slewable, the supply conduit can be fixed with its mouth in a position which is described with relation to the embodiment in which the supply conduit is slidable and/or slewable and preferably is fixable in a position. The supply conduit can e.g. be slidable across a region relative to the flow channel or can be fixed within a region which extends from a position in which the mouth of the supply conduit is arranged in a distance from the level of the inlet opening, respectively from the inlet end outside of the flow channel into a position in which the mouth of the supply conduit is arranged inside the flow channel, e.g. up into a position in which the mouth projects into the section of the flow channel having the smallest inner diameter or beyond this into the flow channel. Optionally, the supply conduit can be slidable, so that its mouth is arranged in a region which extends from a distance from the level of the inlet opening outside of the flow channel across the level of the inlet opening, e.g. up to the section of the flow channel having the smallest inner diameter, or e.g. in a region which extends from the level of the inlet opening up to the supply opening for pressurized gas, which is arranged at or within the flow channel, or in a region which extends from the inlet opening for pressurized gas to the outlet opening of the flow channel. Also in embodiments of the flow channel in which it has a diameter which is constant along its length or from the inlet opening to the outlet opening has an increasing diameter, the supply conduit can be slidable such that its mouth can be positioned in a region which extends from a distance in front of the inlet opening up to the supply opening for pressurized gas in the flow channel, or can be positioned in a region which extends from the supply opening for pressurized gas to the outlet opening.

Optionally, the position of the mouth of the supply conduit can be controlled in dependence from e.g. the pressure and/or from the speed and/or from the mass flow of the mass exiting from the supply conduit or from the conveying rate of a conveyor device, which can be the pressure which is applied to the supply container, or in dependence from the flow rate of a pump arranged in the supply conduit, and/or in dependence from the position of a valve arranged in the supply conduit.

The flow channel has at least one connected pressurized gas line, which is controlled by means of a valve and on the flow channel discharges into at least one supply opening for pressurized gas which is set up to accelerate within the flow channel an air flow from the inlet end to the opposite outlet end. Optionally, the valve is controlled, depending on the signal of a detector for the position of a food on the transport device for food.

Optionally, the supply of pressurized gas to the supply opening is controlled, e.g. the supply of pressurized gas is opened in dependence from a signal of a detector for the presence of a food arranged on the transport device in front of the outlet opening of the flow channel, so that only at detection of a food in front of the outlet opening pressurized gas is introduced in a controlled way into the flow channel. Further optionally, the supply of pressurized gas is controlled in dependence from a signal of a flowmeter. Generally, the pressurized gas of the at least one supply opening can be supplied at a pressure of 0.1 to 15 bar, e.g. 0.1 to 10 bar. Optionally, the pressurized gas can be supplied pulsatingly, e.g. in blasts of a duration of 10 to 3000 ms and at a frequency of up to 3000 blasts/min (approximately 50 per second). For this, the apparatus can be set up to pulsatingly open a valve within the pressurized gas line in a controlled manner. Alternatively, the apparatus can be set up such that the pressurized gas is supplied continuously to the at least one supply opening.

In a preferred embodiment the inlet opening at the inlet end of the flow channel is opened up by a convex surface, which rotationally symmetrically extends about the longitudinal central axis of the flow channel and preferably has a curvature projecting towards the longitudinal central axis of the flow channel, respectively a convex surface, which preferably is parabolic. Optionally, the curvature, resp. the convex surface, projects along the radius to the longitudinal axis of the flow channel. Preferably, the gradient of the curvature increases in the direction towards the longitudinal central axis of the flow channel, so that preferably the gradient increases with decreasing radius in order to form a curvature increasing towards the longitudinal central axis.

Adjacent thereto, e.g. adjacent to the convex surface and opposite the inlet opening, respectively opposite the inlet end, the flow channel has its smallest cross-section and from this smallest cross-section widens in the direction to the outlet opening, respectively to its outlet end, which lies opposite the inlet end, preferably with a conically or parabolically increasing cross-section. The inlet opening that forms the opening of the flow channel is limited by a ring-shaped supply opening for pressurized gas which is connected to the pressurized gas line. Therein, the ring-shaped supply opening is formed by a shoulder which is spaced from the surface which forms the inlet opening and which preferably is convex, so that the cross-section of the supply opening is arranged in a section adjacent to the opening of the inlet end, preferably the supply opening forming an axial section along the longitudinal central axis of the flow channel. The shoulder preferably is ring-shaped, so that together with the spaced convex surface which opens up the inlet opening on the inlet end forms a ring-shaped supply opening for pressurized gas about the longitudinal central axis of the flow channel. Generally, the at least one outlet opening for pressurized gas can be arranged in the form of at least one boring or a tube in the wall of the flow channel in an angle of at maximum 90°, at maximum 75°, preferably at maximum 45° or at maximum 30° or at maximum 15° or at maximum 5° from the inlet end to the longitudinal central axis. Because in this embodiment the diameter of the flow channel increases towards its outlet end, respectively towards its outlet opening, the flow channel does not form a nozzle the diameter of which decreases towards the outlet end, but optionally a Laval nozzle, in order to convert the pressure of the applied pressurized gas into gas velocity.

In an alternative embodiment, the flow channel at least sectionwise can have a cylindrical inner cross-section, optionally having a diameter which is constant for its length, or with a diameter which sectionwise increases or decreases from its inlet end to the outlet end. The at least one outlet opening for pressurized gas can e.g. be arranged in the form of at least one boring or a tube in the wall of the flow channel in an angle of at maximum 75°, preferably at maximum 45° or at maximum 30° or at maximum 5° from the inlet end to the longitudinal central axis. In this embodiment pressurized gas streaming through the supply opening for pressurized gas into the flow channel drags along the air within the flow channel and accelerates it to the outlet opening. Generally, the flow channel at its inlet opening is open to the environment so that gas from the environment can be sucked into the flow channel when pressurized gas is applied to the flow channel, which pressurized gas flows through the at least one supply opening for pressurized gas into the flow channel.

The flow channel is directed with its longitudinal central axis and its outlet opening towards a transport device for foods. Preferably, at least one flow channel is arranged on each side of the transport device and is directed towards it. The transport device can be an approximately horizontally running conveyor belt having openings, e.g. a circulating grid belt or spaced apart belt elements circulating in parallel, and a flow channel be directed from above and a further flow channel can be directed from below against the transport belt. Alternatively, the transport device can be a row of moveable hangers, e.g. hooks, from which foods can be suspended, and at least one flow channel each can be directed from each side against an area of the transport device or against an area below the transport device, in which area the food is arranged.

Optionally, the flow channel at its outlet end can be encompassed completely or partially by a guidance element which is arranged in a radial distance from the flow channel and which extends coaxially to the longitudinal central axis of the flow channel, e.g. a tube section which extends coaxially and with a radial distance around the outlet end, respectively around the outlet opening. The guidance element can have a constant inner diameter, an inner diameter decreasing in flow direction or an inner diameter decreasing in flow direction, which adjacently increases to its outlet. A flow channel which at least at its outlet end is encompassed by a guidance element allows focusing of the exiting mass jet, so that the mass can be applied to the food more precisely.

Optionally, pressurized gas can be applied to the guidance element, the pressurized gas forming a stream of gas between the guidance element and the flow channel. A guidance element to which pressurized gas is applied can be closed or open at its end which is opposite its outlet end, respectively opposite the outlet opening. For application of pressurized gas which generates a stream of gas between the guidance element and the flow channel in the direction from the inlet end, respectively from the inlet opening towards the outlet end, respectively to the outlet opening of the flow channel, respectively in the direction of the flow of gas and mass within the flow channel, the guidance element e.g. has at least one, preferably at least two supply openings for pressurized gas distributed about its circumference. Upon application of pressurized gas the guidance element can form a sheath stream around the stream of gas and mass exiting from the flow channel. Such a sheath stream can increase the alignment and speed of the stream of gas and mass, e.g. focus this stream, which exits from the flow channel.

Optionally, the pressurized gas which is applied to the guidance element and/or the pressurized gas which is applied to the flow channel is ionized. For the ionization of the pressurized gas a ionization device can be provided, e.g. between the respective pressurized gas line and the guidance element, respectively the flow channel.

Further optionally, the pressurized gas which is applied to the guidance element, or the pressurized gas which is applied to the flow channel, can be cooled, e.g. temperature-controlled to a temperature of −120 to +250° C. To this end, the pressurized gas line and/or the pressurized gas source can be cooled, respectively can be set up to provide the pressurized gas at such a temperature. The pressurized gas optionally is air or nitrogen or carbon dioxide or a mixture of at least two of these.

It was found that a process for applying liquid masses by means of the apparatus according to the invention results in the mass applied to the food having an even distribution also of the solid ingredients within the coating on the food. Further it was found that the mass coated onto the food has gaseous inclusions which upon subsequent freezing are maintained at least in part and preferably provide the impression of a large volume to the coated mass.

The apparatus and the process are especially suited for applying liquid masses which preferably contain pieces distributed therein, having a dynamic viscosity in the range of 0.5 mPas to 200 Pas, e.g. 50 to 200 or up to 150 Pas or up to 1×10⁴ mPas at the temperature at which the process is performed, measured at a shear rate of 1/s in a rotary viscosimeter. The temperature at which the process is performed lies e.g. at −80° C. to 310° C. or up to 15° C., preferably at up to 5° C., e.g. at −20° C. up to 3° C. or at −5° C. or 0° C. up to 5° C. or up to 3° C. Preferably, the mass, optionally the pressurized gas admitted into the flow channel is temperature-controlled to a temperature in the range at which the process is performed. Alternatively, the mass can be temperature-controlled independently from the temperature at which the process is performed, up to +310° C. to −80° C., e.g. to −20° C. up to 310° C. or up to 15° C., preferably up to 5° C., e.g. to −20° C. up to 3° C. or up to −5° C. or 0° C. up to 5° C. or up to 3° C. Performing the process and the temperature-controlling of the mass to a temperature below 0° C. is e.g. preferred for oil and emulsions in order to apply these in a bigger layer thickness and/or in order to obtain an even distribution and/or a good adhesion for the pieces contained in the mass.

For the temperature-controlling of the mass, e.g. preferably the supply container can be cooled to this temperature. The viscosity can be adjusted by known means, e.g. by adding thickening agents and/or finely distributed ingredients to the mass.

Optionally, the apparatus has a freezing device, through which the foods are transported prior to and/or after the application of the mass. The freezing device, which is set up to cool the foods prior to the application of the mass to a temperature of below 0° C., e.g. to a temperature in the range of −70 to −5° C. or up to −20° C. may encompass the transport device only in a region ahead of the region in which the flow channel is directed onto the transport device or may also encompass the region in which the flow channel is directed onto the transport device. Accordingly, in the process the foods prior to the application of the mass may be cooled to a temperature of below 0° C., e.g. to a temperature in the range of from −70 to −5° C. or to −20° C., optionally the foods can also be cooled during the application of the mass to a temperature of below 0° C., e.g. to a temperature in the range of from −70 to −5° C. or to −20° C. In this manner, the adherence of the applied mass, optionally having gaseous inclusions, to the foods can be increased. Accordingly, the device is suitable for use an application device of liquid masses onto foods which are cooled to a temperature of below 0° C., e.g. to a temperature in the range of from −70 to −5° C. or to −20° C.

Preferably, the device has a cooling device, which is set up to cool the foods subsequent to the application of the mass to a temperature of below 0° C., e.g. to a temperature in the range of from −70 to −5° C. or to −20° C.

In the process the least one mass, which is pulverized, preferably liquid, homogeneous or liquid with pieces contained therein, wherein the pieces preferably have a size or size distribution of 0.1 mm to 0.5 or from 0.5 to 4 mm, e.g. from 2 mm up to 10 mm, more preferred up to 5 or up to 3 mm in their largest extension, are guided through the mouth of the supply conduit, wherein the supply conduit is in parallel or inclined in an angle to the longitudinal central axis of the flow channel or is swivelled in an angle to the longitudinal central axis of the flow channel, optionally along one or two axes, which are perpendicular to the longitudinal central axis of the flow channel, or is only slided coaxially to the longitudinal central axis of the flow channel and is fixed in a position, in which its mouth is arranged in an area which extends from a distance in front of the inlet end, respectively in front of the inlet opening of the flow channel to the inside of it, e.g. up to its section having its smallest diameter or up to in front of the at least one supply opening for pressurized gas, or in a region which extends from the supply opening for pressurized gas to the outlet opening of the flow channel.

During the process, pressurized gas is guided through the at least one supply opening for pressurized gas adjacent to or into the flow channel so that within the flow channel gas flows from the inlet opening to the outlet opening, and thereat sucks gas from the environment into the inlet opening. The mass guided through the supply conduit enters into the flow in front of the inlet opening of the flow channel or enters into the flow within the flow channel and subsequently exits from the outlet opening of the flow channel with the pressured gas supplied and the gas sucked into the inlet opening from the environment. This exiting flow is directed onto the foods which by means of a transport device are guided past the outlet opening in a distance from the outlet opening. Preferably, the transportation device runs continuously and the mass is continuously applied to the foods which are continuously transported on the transport device.

Optionally, pressurized gas streams into the intermediate space between a guidance element, which with a spacing encompasses the outlet opening of the flow channel, and/or gas from the environment, e.g. environmental air, flows through the open end of this immediate space. Therein, the pressurized gas moves into the intermediate space and/or the gas that flowed in from the environment into the intermediate space moves between the guidance element and the flow channel in the direction from the inlet end to the outlet end of the flow channel and can form a sheath gas flow around the mass exiting from the outlet opening and the exiting gas.

Optionally, the apparatus can have a device for conveying a further mass, which can be pulverized or liquid, into the spacing between the guidance element and the flow channel. Therein, in addition to the pressurized gas a further pulverized or liquid mass is introduced into the sheath flow.

Optionally, the apparatus can have at least one, preferably at least two second supply conduits, which discharge into the flow channel between the supply opening for pressurized gas and the outlet opening. Such second supply conduits can be connected to a pressurized gas source, to a supply conduit for a mass, pulverized or liquid, or at least two of these, in order to additionally press pressurized gas and/or a mass into the flow channel in front of the outlet opening. Therein, the second supply conduits can discharge into the flow channel between the inlet opening for pressurized gas and its outlet opening, optionally between the smallest diameter of the flow channel and the outlet opening.

The second supply conduits can project over the inner wall of the flow channel into it, or can discharge flush within the inner wall of the flow channel. Generally, the second supply conduits can have a mouth which is blunt or bevelled. Optionally, a valve within the supply conduit for the mass and/or a valve in the pressurized gas line, which discharges into at least one supply opening for pressurized gas at or within the flow channel is controlled in dependence from a detector which senses the position of foods on the transport device.

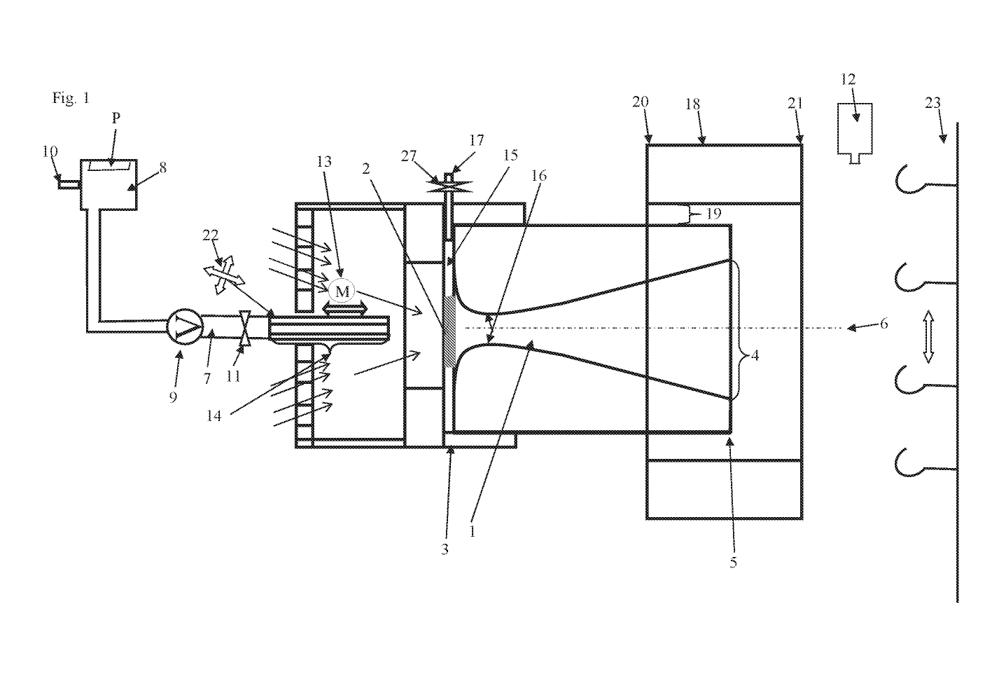

FIG. 1 shows a device having a flow channel 1 which from its inlet opening 2 at the inlet end 3 extends to its outlet opening 4 at the outlet end 5 about a longitudinal central axis 6. At the inlet opening 2, a supply conduit 7 discharges, which is connected to a supply container 8 for a liquid mass. An optional pump 9 is arranged as a conveyor device within the supply conduit 7, preferably, as a conveyor device, pressure is applied to the supply container 8, e.g. by a pressurized gas connection 10, and a controlled valve 11 is arranged in the supply conduit 7. The valve 11, especially upon application of pressure, which can e.g. be constant, to the supply container, is controlled in dependence on the signal of a detector 12, which senses the presence of a food in a position in front of the outlet opening 4 of the flow channel 1. Such a detector 12 can e.g. be a camera.

The supply conduit 7, which preferably at least in its terminal section 14 which spans up its mouth, is a pipe, is slidably guided in relation to the flow channel 1, e.g. by means of a controlled servomotor 13. As preferred, the terminal section 14 of the supply conduit 7 is arranged along the longitudinal central axis 6 of the flow channel 1 and is slidable. Preferably, the terminal section 14 of the supply conduit 7 is slidable from a first position, in which its mouth is arranged in a region around the inlet opening 2 of the flow channel 1, wherein this region can extend from a distance in front of the inlet opening 2 and opposite to the flow channel 1 up to a distance from the inlet opening 2 into the flow channel 1, e.g. in a distance of from 0.1 mm to 30 mm, preferably of from 0.2 to 10 mm from the inlet opening 2 in front of, respectively outside of the flow channel 1, in a controlled manner into a second position, in which its mouth is arranged into the region inside the flow channel 1, which is arranged downstream of at least one supply opening 15 for pressurized gas and which extends in the direction of the outlet opening 4, optionally into or beyond a region of the flow channel 1 in which this has its smallest inner diameter, wherein the region can be restricted by the outlet opening 4. The double arrows standing perpendicular to one another indicate the at least one sliding axis 22, optionally two sliding axes 22 perpendicular to one another, which are perpendicular to the longitudinal central axis 6 of the flow channel 1, along which the supply conduit 7 is generally guided slidingly additionally or in alternative to the slidability along or in parallel to the longitudinal central axis 6.

In the embodiment shown in FIG. 1 the flow channel 1 at its inlet end 3 has a convex surface 16, which rotationally symmetrically extends about the longitudinal central axis 6 and tapers in the direction towards the outlet end 5 to a section of smallest cross-section, and adjacent thereto widens to the outlet opening, wherein the cross-section tapers in the direction of the longitudinal central axis from the inlet end 5 convexly to the section of smallest diameter with increasing gradient of its curvature, and subsequently widens to the outlet opening 4 conically, preferably parabolically. The supply opening 15 for pressurized gas is ring-shaped and arranged adjacent to the convex surface 16 at the inlet end 3 of the flow channel 1. This inlet opening 15 is preferably arranged in parallel to the adjacent convex surface 16. The inlet opening 2 of the flow channel 1 is generally open to the environment, so that gas from the environment is sucked into the inlet opening 2, when pressurized gas flows through the supply opening 15 into the flow channel 1.

Upon supply of pressurized gas through the supply opening 15 the pressurized gas flows along the convex surface into the flow channel 1 and generates a flow which exits out of the outlet opening 4 and at the inlet opening 2, gas from the environment, e.g. environmental air, is sucked into the flow channel 1. The supply conduit 7 conducts mass from the supply container 8 up to its mouth, so that the mass after exiting from the mouth of the supply conduit 7 is captured by the gas flow within the flow channel 1 and is moved through the flow channel 1. Therein, the gas flow can also capture mass, when the mouth of the supply conduit 7 is arranged in front of the inlet opening 2, because the gas flow in front of the inlet opening 2 generates a suction, which is directed into the flow channel 1. Accordingly, in the process a flow of pressurized gas, mass and sucked-in gas flows along the flow channel 1 and exits out of its outlet opening 4. The supply conduit 7 for pressurized gas by means of a pressurized gas line 17 is connected to a source of pressurized gas, e.g. a pressurized gas container or a gas compressor.

In FIG. 1, an optional guidance element 18 with a radial spacing 19 encompasses, preferably concentrically, the flow channel 1 and extends at least beyond the outlet end 5 of the flow channel 1. In FIG. 1 the guidance element 18 has a round inner cross-section which is constant over its length. In the radial spacing 19 between the flow channel 1 and the guidance element 18 gas from the environment can be carried along by the flow of mass and gas exiting out of the outlet opening 4. Optionally, pressurized gas can be applied to the guidance element 18, the pressurized gas flowing along the radial distance 19 in the direction as the flow of gas and mass within the flow channel 1. Therein, the guidance element 18 can be open at its first end 20 facing the inlet end 3 of the flow channel 1 and can be open at its opposite outlet end 21. The transport device 23 is moveable in perpendicular to the longitudinal central axis 6 in a distance in front of the outlet opening 4, as indicated by the double-headed arrow.

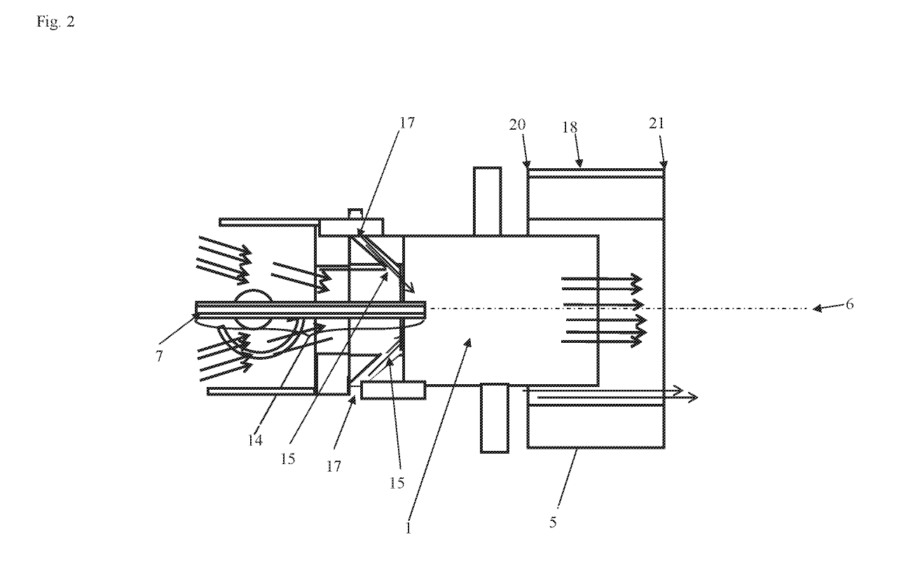

FIG. 2 shows an embodiment in which the flow channel 1 adjacent to its inlet end 3 has a constant, respectively cylindrical inner cross-section, has at least one supply opening for pressurized gas within the flow channel 1 in a region which is spaced from the inlet opening 2 and the outlet opening 4. The supply opening 15 discharges in an angle against the longitudinal axis of the flow channel 1 in order to generate a flow of air from the inlet opening 2 to the outlet opening 4. As in FIG. 1, the guidance element 18 is connected for application of pressurized gas and is arranged to generate a flow of gas between the guidance element 18 and the flow channel 1 in the direction from the inlet opening 2 towards the outlet opening 4. The supply opening 15 can generally discharge flush in the inner surface of the flow channel 1 as this is also depicted in FIG. 2. The supply opening 15 is connected to a pressurized gas line 17.

In the section of the flow channel 1, which extends between the at least one supply opening 15 for pressurized gas and the outlet opening 4, the flow channel 1 can have a cylindrical inner cross-section, e.g. with the same inner diameter as the inner cross-section adjacent to the inlet end 3 or with a larger or smaller inner diameter.

For supply of pressurized gas into the radial spacing 19 between the optional guidance element 18 and the flow channel 1 an annular gap 25 can encompass the flow channel 1 and can be connected to the ring-shaped radial spacing 19. In this manner the guidance element 18 and the annular gap 25, to which a pressure gas line is connected, form a device for generating an accelerated sheath flow around the gas flow that exits from the outlet opening 4.

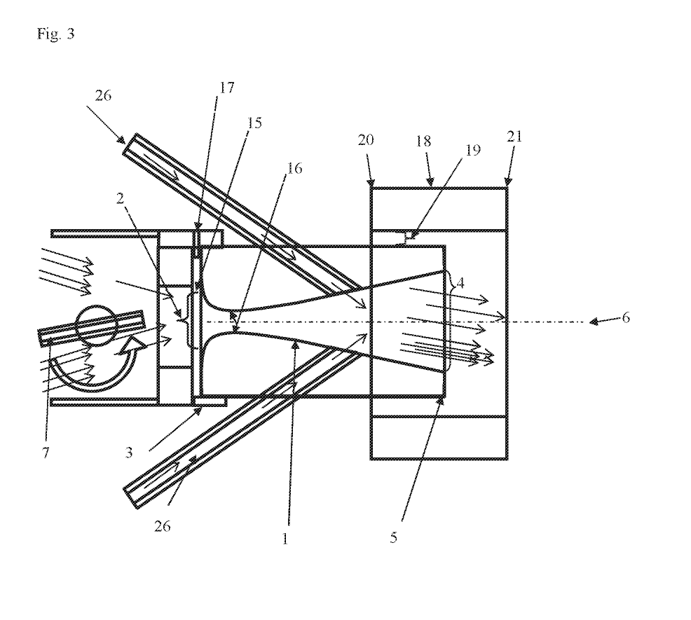

FIG. 3 shows an embodiment in which at least one, preferably at least two second supply lines 26 discharge into the flow channel 1 between the supply opening 15 for pressurized gas and the outlet opening 4. Such second supply lines 26 can be connected to a pressurized gas source, to a supply conduit 7 for a mass, pulverized or liquid, or to at least two of these, in order to additionally press pressurized gas and/or a mass into the flow channel 1. In the embodiment of the flow channel 1 shown, the second supply lines 26 preferably discharge in a region of the flow channel 1 between its smallest diameter and the outlet opening 4.

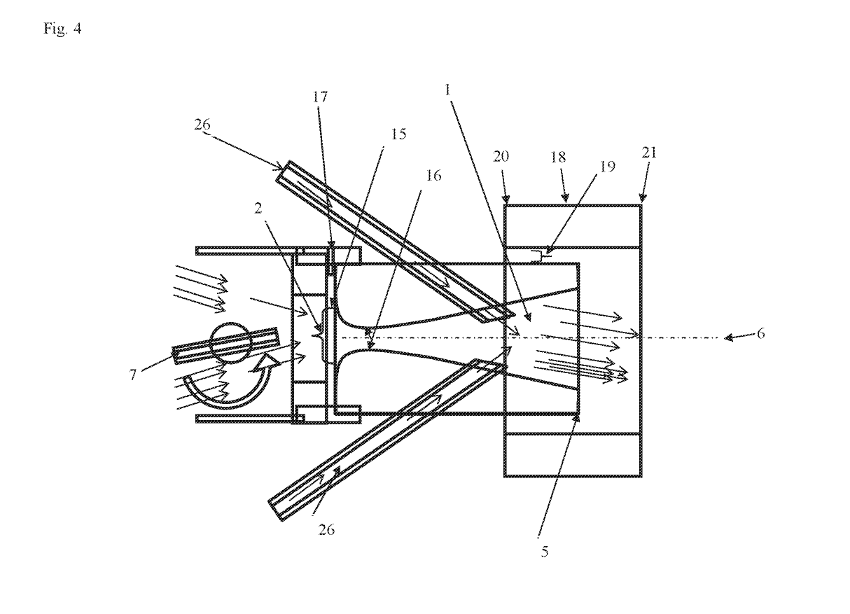

FIG. 4 shows an embodiment, corresponding to the one of FIG. 3, wherein however, the second supply lines 26 project over the inner wall of and into the flow channel 1. Generally, the second supply lines 26 can have a mouth which is blunt or bevelled.

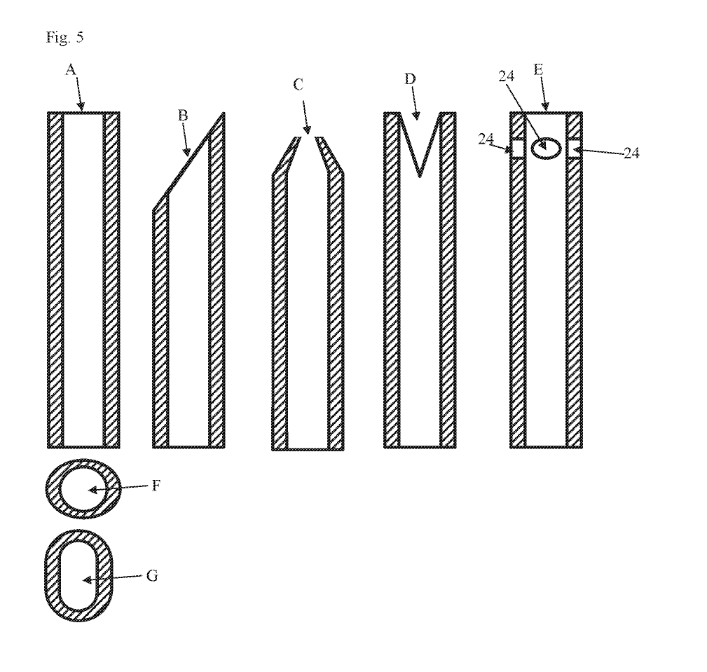

FIG. 5 shows possible embodiments of the mouth of the supply conduit 7, in which A is a supply conduit, the mouth of which is arranged in perpendicular to its longitudinal axis, at B a bevelled mouth B, at C a tapered mouth C, the cross-section of which is smaller than the cross-section of the adjacent supply conduit 7, at D a cylindrical supply conduit 7, which is incised, e.g. V-shaped or rectangularly, in two sections adjacent and opposite to the mouth D, at E a mouth E, which is arranged in perpendicular to the longitudinal axis of the supply conduit 7 and in a distance beyond the mouth E at least one, preferably at least two, e.g. three or four borings 24 in the supply conduit 7.

In each embodiment the supply conduit 7 can have an inner cross-section which preferably is constant up to adjacent its mouth, and which optionally has a circle-shaped cross-section F or an oval cross-section G.

It has shown that the embodiment of the mouth A-E, optionally in connection with the embodiment of the cross-section F, G of the supply conduit, influences the distribution of the mass that exits from the outlet opening 4.

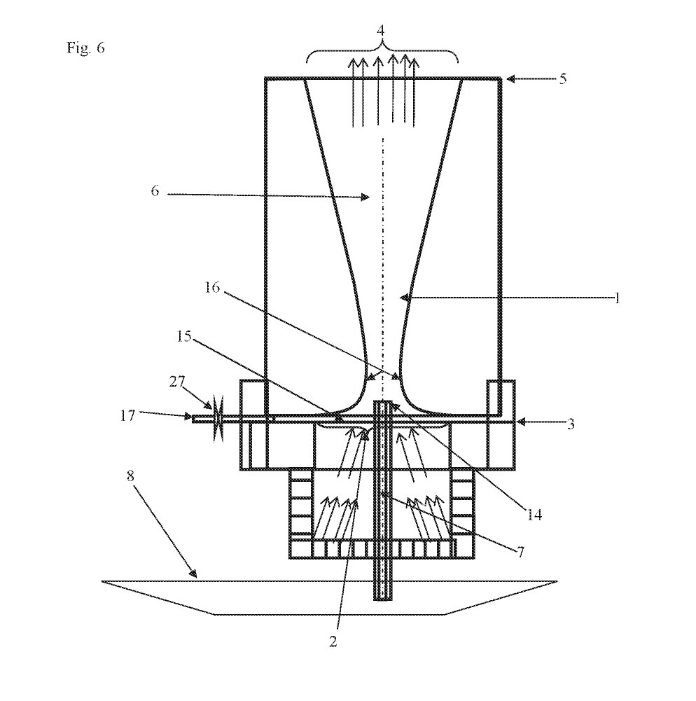

FIG. 6 shows an embodiment in which the supply conduit 7 can be fixed relative to the flow channel 1. The one end of the supply conduit 1 discharges in a region which is spaced from the flow channel 1 and/or which can end inside the flow channel 1, and the other end of the supply conduit 7 is arranged in a supply container 8 in order to suck-in mass therefrom. Therein, the vacuum generated by the flow channel 1 acts through the supply conduit 7 up to its end, which is arranged within the supply container 8 and therefrom sucks the mass into the supply conduit 7. The flow channel 1 can be arranged vertically, especially arranged above a supply container 8, wherein the supply conduit 7 projects into the volume of the supply container 8. Especially in this embodiment the supply conduit 7 can be formed without a pump 9 therein.

Reference signs:

| | |
|---|---|
| 1 | flow channel |
| 2 | inlet opening |
| 3 | inlet end, |
| 4 | outlet opening |
| 5 | outlet end |
| 6 | longitudinal central axis |
| 7 | supply conduit |
| 8 | supply container |
| 9 | pump |
| 10 | pressurized gas supply |
| 11 | controlled valve |
| 12 | detector |
| 13 | controlled servomotor |
| 14 | terminal section of the supply conduit |
| 15 | supply opening for pressurized gas |
| 16 | convex surface |
| 17 | pressurized gas line |
| 18 | guidance element |
| 19 | radial distance |
| 20 | first end of the guidance element |
| 21 | outlet end of the guidance element |
| 22 | sliding axis |
| 23 | transport device |
| 24 | boring |
| 25 | annular gap |
| 26 | second supply line |
| 27 | valve |
| A-E | mouth |
| F | circle shaped cross-section |
| G | oval cross-section |

1. Apparatus for applying a mass onto food, comprising at least one pressurized gas line connected to a flow channel and having a transport device to transport the foods along in front of an outlet opening of the flow channel, wherein the inlet opening is opened up on the inlet end of the flow channel by a convex surface which extends rotationally symmetrically about the longitudinal central axis of the flow channel and has a curvature projecting towards the longitudinal central axis of the flow channel, the gradient of which increases in the direction towards the longitudinal central axis of the flow channel having its smallest cross-section adjacent thereto and opposite to the inlet opening of the flow channel, and from this smallest cross-section widens in the direction towards the outlet opening, wherein the inlet opening is delimited by a ring-shaped supply opening for pressurized gas which is connected to the pressurized gas line, and a supply conduit discharges in a region in which the flow channel generates vacuum, wherein this region extends from in front of the inlet opening to inside the flow channel, and the opposite open end of the supply conduit is arranged in a container for the mass.

2. Apparatus according to claim 1, wherein the supply conduit has no pump and conveys mass to its mouth only by the vacuum generated by the flow channel.

3. Apparatus according to claim 1, wherein the supply conduit for the mass is guided slidably in relation to the flow channel and can be fixed in a position so that the mouth of the supply conduit is slidable in a region and can be fixed in a position of the region which extends from a distance in front of the inlet opening to inside the flow channel.

4. Apparatus according to claim 1, wherein the supply conduit is arranged in parallel or in an angle to the longitudinal central axis of the flow channel and is guided slidably in parallel to the longitudinal central axis of the flow channel and/or in one or in two dimensions which are perpendicular to the longitudinal central axis.

5. Apparatus according to claim 1, wherein the supply conduit is guided slewably in an angle to the longitudinal central axis of the flow channel.

6. Apparatus according to claim 1, wherein the position of the mouth of the supply conduit is controlled and slidably guided in dependence on the pressure and/or on the velocity and/or on the mass flow of the mass exiting from the supply conduit or on the conveying rate of a conveyor device which is arranged for conveying the mass through the supply conduit.

7. Apparatus according to claim 1, wherein the mouth of the supply conduit is positionable in a region which extends from a distance in front of the inlet opening up to a supply opening for pressurized gas at the or within the flow channel, or is positionable in a region which extends from the supply opening for pressurized gas on the or within the flow channel up to the outlet opening.

8. Apparatus according to claim 1, wherein the flow channel has at least one connected pressurized gas line which is controlled by means of a valve and discharges at or within the flow channel in at least one supply opening for pressurized gas, which pressurized gas line generates within the flow channel an air flow from the inlet opening towards the opposite outlet opening.

9. Apparatus according to claim 1, wherein the valve within the pressurized gas line is controlled in dependence on a signal of a detector for the position of a food on the transport device for foods.

10. Apparatus according to claim 1, wherein a supply container for the mass is connected to the end of the supply conduit opposite of its mouth and as a conveyor device for conveying the mass a pump is arranged in the supply conduit, and/or as a conveyor device for conveying the mass pressurized gas is applied to the supply container, or a wall of the supply container is formed as a piston loaded against the inner volume of the supply container, and a controlled valve is arranged in the supply conduit.

11. Apparatus according to claim 1, wherein a guidance element encompasses the flow channel at its outlet opening in a radial distance, wherein the guidance element extends coaxially to the longitudinal central axis of the flow channel.

12. Apparatus according to claim 11, wherein the guidance element is connected to a device for the application of pressurized gas which device is set up to generate a gas flow between the guidance element and the flow channel in the direction from the inlet opening to the outlet opening.

13. Apparatus according to claim 12, further comprising a device for conveying a further pulverized or liquid mass into the radial distance between the guidance element and the flow channel.

14. Apparatus according to claim 1, comprising at least one second supply line which discharges between the supply opening for pressurized gas and the outlet opening into the flow channel and which is connected to at least one pressurized gas source and/or to a supply conduit for a mass.

15. Process for a mass to foods, wherein the mass is liquid with pieces distributed therein, which have a size of 1 mm up to 10 mm, the process comprising transporting the foods past and in front of an outlet opening of a flow channel, moving the through the outlet opening of the flow channel against the foods, wherein the inlet opening at the inlet end of the flow channel is opened up by a convex surface which extends rotationally symmetric about the longitudinal central axis of the flow channel and has a curvature projecting towards the longitudinal central axis of the flow channel, the gradient of which curvature increasing in the direction towards the longitudinal central axis of the flow channel, the flow channel adjacent thereto and opposite to the inlet opening has its smallest cross-section and from this smallest cross-section widens in the direction towards the outlet opening, wherein the inlet opening is limited by a ring-shaped supply opening for pressurized gas which is connected to the pressurized gas line and a supply conduit for the mass, which conducts the mass from a supply container to the flow channel, discharges in a region in which the flow channel generates vacuum, wherein the region extends from a distance in front of the inlet opening to inside the flow channel.

16. Process according to claim 15, wherein the supply conduit for the mass which conducts the mass from a supply container to the flow channel is guided slidably in relation to the flow channel and is fixed in a position, and/or the position of the mouth of the supply conduit is controlled in dependence on the pressure and/or on the velocity and/or on the mass flow of the mass exiting from the supply conduit, or on the conveying rate of a conveyor device which is set up for conveying the mass through the supply conduit.

17. Process according to claim 15, wherein the region within which the mouth of the supply conduit is positioned, extends from a distance in front of the inlet opening to a supply opening for pressurized gas at the or inside the flow channel, or extends from the supply opening for pressurized gas at the or inside the flow channel to the outlet opening.

18. Process according to claim 15, wherein the flow channel has at least one connected pressurized gas line which is controlled by means of a valve and discharges at the and/or within the flow channel in at least one supply opening for pressurized gas which in the flow channel generates an air flow from the inlet opening to the opposite outlet opening.

19. Process according to claim 15, wherein the valve in the pressurized gas line is controlled in dependence on the signal of a detector for the position of a food on the transport device for foods.

20. Process according to claim 15, wherein a supply container for the mass is connected to the end of the supply conduit opposite of its mouth and the mass is conveyed by means of a conveyor device to the mouth, wherein as a conveyor device within the supply conduit there is arranged a pump and/or as a conveyor device pressurized gas is applied to the supply container, or a wall of the supply container is formed as a piston loaded against the inner volume of the supply container, and a controlled valve is arranged in the supply conduit.

21. Process according to claim 15, wherein a guidance element in a radial distance encompasses the flow channel at its outlet opening, wherein the guidance element extends coaxially to the longitudinal central axis of the flow channel, and between the guidance element and the flow channel a sheath flow is formed around the flow of gas and mass exiting out of the outlet opening.

22. Process according to claim 21, wherein the guidance element is connected to a device for application of pressurized gas which device forms a gas flow between the guidance element and the flow channel in the direction from the inlet opening to the outlet opening.

23. Process according to claim 15, wherein pressurized gas and/or mass is pressed through at least one second supply line into the flow channel.
